(19) United States
(12) Patent Application Publication
(10) Pub. No.: US 2025/0211997 A1
(43) Pub. Date: Jun. 26, 2025

(54) METHOD AND DEVICE FOR PROCESSING INFORMATION, COMMUNICATION DEVICE, AND STORAGE MEDIUM

(71) Applicant: Beijing Xiaomi Mobile Software Co., Ltd., Beijing (CN)

(72) Inventor: Yang SHEN, Beijing (CN)

(21) Appl. No.: 18/847,578

(22) PCT Filed: Mar. 23, 2022
(86) PCT No.: PCT/CN2022/082598

§ 371 Date: Sep. 16, 2024

(51) Int. Cl. H04W 12/60; H04W 12/63; H04W 60/04; H04W 64/00; H04W 84/04

(52) U.S. Cl. CPC H04W 12/66; H04W 12/63; H04W 60/04; H04W 64/00; H04W 84/042

(57) ABSTRACT

A method and device for processing information, a communication device, and a storage medium are provided. The method, performed by a first network element, includes: obtaining trusted location information of a user equipment (UE); and sending the trusted location information to a second network element or the UE.

### CROSS-REFERENCE TO RELATED APPLICATIONS

The present application is a U.S. National Stage of International Application No. PCT/CN2022/082598, filed on Mar. 23, 2022, the contents of all of which are incorporated herein by reference in their entirety for all purposes.

### BACKGROUND OF THE INVENTION

After powering on, a user equipment (UE) needs to register with the network. Generally, the UE may also perform periodic registration updates. The base station broadcasts one or more tracking area identifiers (TAIs). During the initial access process, the UE sends a registration request message to the network side.

### SUMMARY OF THE INVENTION

The present disclosure relates to, but is not limited to, the technical field of wireless communications, in particular to a method and device for processing information, a communication device, and a storage medium. A method and device for processing information, a communication device, and a storage medium are provided according to embodiments of the present disclosure.

According to a first aspect of embodiments of the present disclosure, a method for processing information is provided. The method is performed by a first network element and includes:
obtaining trusted location information of a user equipment (UE); and
sending the trusted location information to a second network element or the UE.

According to a second aspect of embodiments of the present disclosure, a method for processing information is provided. The method is performed by a second network element, and includes:
receiving trusted location information of a user equipment (UE) sent by a first network element; and
storing the trusted location information.

According to a third aspect of embodiments of the present disclosure, a method for processing information is provided. The method is performed by a UE and includes:
receiving trusted location information of the UE sent by a first network element; and
storing the trusted location information.

According to a fourth aspect of embodiments of the present disclosure, a communication device is provided. The communication device includes a processor, a transceiver, a memory, and an executable program stored on the memory and capable of being run by the processor, where the processor implements the method for processing information provided by the first aspect, the second aspect, or the third aspect above when running the executable program.

According to a fifth aspect of embodiments of the present disclosure, a non-transitory computer storage medium is provided. The non-transitory computer storage medium stores an executable program. The executable program when executed by a processor, implements the method for processing information provided by the first aspect, the second aspect, or the third aspect above.

It is to be understood that the above general descriptions and later detailed descriptions are merely examples and illustrative, which does not limit the embodiments of the present disclosure.

### BRIEF DESCRIPTION OF DRAWINGS

Accompanying drawings here are incorporated into the specification, which constitute a part of the specification. The drawings illustrate embodiments in accordance with the present disclosure and, together with the specification, serve to explain the principles of the embodiments of the present disclosure.

FIG. 1 is a schematic structural diagram of a wireless communication system according to an example.

FIG. 2 is a schematic flowchart of a method for processing information according to an example.

FIG. 3 is a schematic flowchart of a method for processing information according to an example.

FIG. 4 is a schematic flowchart of a method for processing information according to an example.

FIG. 5 is a schematic flowchart of a method for processing information according to an example.

FIG. 6 is a schematic flowchart of a method for processing information according to an example.

FIG. 7 is a schematic flowchart of a method for processing information according to an example.

FIG. 8 is a schematic flowchart of a method for processing information according to an example.

FIG. 9 is a schematic flowchart of a method for processing information according to an example.

FIG. 10 is a schematic flowchart of a method for processing information according to an example.

FIG. 11 is a schematic flowchart of a method for processing information according to an example.

FIG. 12 is a schematic flowchart of a method for processing information according to an example.

FIG. 13 is a schematic structural diagram of a device for processing information according to an example.

FIG. 14 is a schematic structural diagram of a device for processing information according to an example.

FIG. 15 is a schematic structural diagram of a device for processing information according to an example.

FIG. 16 is a schematic structural diagram of a device for processing information according to an example.

FIG. 17 is a schematic structural diagram of a UE according to an example.

FIG. 18 is a schematic structural diagram of a communication device according to an example.

### DETAILED DESCRIPTION OF THE INVENTION

Examples will be described in detail here, instances of which are illustrated in the accompanying drawings. When the following description relates to the accompanying drawings, the same numbers in different accompanying drawings refer to the same or similar elements unless otherwise indicated. The embodiments described in the following examples do not represent all embodiments consistent with the examples of the present disclosure. Rather, they are merely instances of devices and methods consistent with some aspects of the appended claims of the present disclosure.

The terms used in the examples of the present disclosure is for the purpose of describing particular embodiments merely and are not intended to limit the examples of the present disclosure. As used in the examples of the present disclosure, singular forms “a,” “an” and “the/said” are intended to include plural forms as well, unless otherwise indicated in the context clearly. It should be understood that the term “and/or” as used here refers to and encompasses any or all possible combinations of at least one of associated listed items.

It should be understood that although the terms of “first,” “second,” “third” and the like may be used in the examples of the present disclosure to describe various information, such information should not be limited to these terms. These terms are merely used to distinguish the same type of information from each other. For example, first information may also be referred to as second information, and similarly, second information may also be referred to as first information, without departing from the scope of the examples of the present disclosure. The word “if” as used here may be construed to mean “at the time of,” or “when,” or “in response to determining,” depending on the context.

In the related art, after powering on, a user equipment (UE) needs to register with the network. Generally, the UE may also perform periodic registration updates. The base station broadcasts one or more tracking area identifiers (TAIs). During the initial access process, the UE sends a registration request message to the network side. Upon receiving the registration request message from the UE, the base station sends the broadcasted TAI along with the registration request message to the access and mobility management function (AMF). If the base station knows the current tracking area (TA) of the UE, it will send the TAI of the TA where the UE is currently located to the AMF. Upon receiving the TAI, the AMF can construct the registration area (RA) for the UE based on the received TAI, etc.

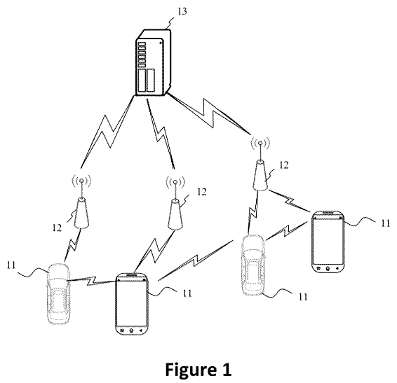

Referring to FIG. 1, FIG. 1 illustrates a schematic structural diagram of a wireless communication system according to an example of the present disclosure. As shown in FIG. 1, the wireless communication system is a communication system based on a cellular mobile communication technology. The wireless communication system may include: a plurality of UEs 11 and a plurality of access devices 12.

The UE 11 may refer to devices that provide a user with voice and/or data connectivity. The UE 11 may communicate with one or more core networks via a radio access network (RAN). The UE 11 may be internet of things UE, such as sensor devices, mobile phones (or “cellular” phones), and computers with internet of things UE. For example, the UE may be fixed, portable, compact, handheld, computer built-in or vehicle-mounted devices. For example, the UE may be a station (STA), a subscriber unit, a subscriber station, a mobile station, a mobile, a remote station, an access point, a remote UE (remote terminal), an access UE (access terminal), a user terminal, a user agent, a user device, or a user equipment (UE). Alternatively, the UE 11 may also be unmanned aircraft devices. Or the UE 11 may also be vehicle-mounted devices, such as a trip computer with a wireless communication function, or a wireless communication device connected with an external trip computer. Or the UE 11 may also be roadside devices, such as a streetlight, traffic signal, or other roadside devices with wireless communication functions.

The access devices 12 may be network side devices in the wireless communication system. The wireless communication system may be the 4th generation mobile communication (4G) system, also referred as to a long term evolution (LTE) system. Or the wireless communication system may be a 5G system, also referred as to a new radio (NR) system or 5G NR system. Or the wireless communication system may be a next-generation system of the 5G system. An access network in the 5G system may be referred as to a new generation-radio access network (NG-RAN). Or it is an MTC system.

The access devices 12 may be evolved access devices (eNBs) adopted in the 4G system. Or the access devices 12 may also be access devices (gNBs) used in 5G system with a centralized distributed architecture. When the access devices 12 adopt the centralized distributed architecture, they typically each include a central unit (CU) and at least two distributed units (DUs). Protocol stacks of a packet data convergence protocol (PDCP) layer, a radio link control (RLC) layer and a media access control (MAC) layer are configured in the central unit; and protocol stacks of physical (PHY) layers are configured in the distributed units, and the specific implementations of the access devices 12 are not limited in the embodiments of the present disclosure.

The access devices 12 and the UE 11 may establish wireless connection via an air interface. In different implementations, the air interface is an air interface based on the 4th generation mobile communication (4G) standard; or, the air interface is an air interface based on the 5th generation mobile communication (5G) standard, such as new radio; or, the air interface may also be air interface based on the next-generation mobile communication standard of 5G.

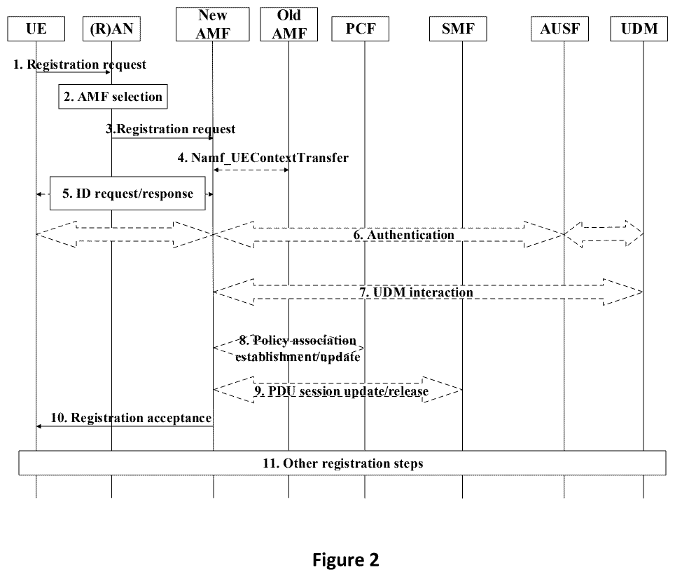

FIG. 2 illustrates a process of a registration update for UE, which may specifically include the following.

1) A registration request message is sent to a radio access network (RAN) by the UE. The registration request message may include: a registration type, a subscription concealed identifier (SUCI) or a 5G-globally unique temporary identity (GUTI) or a permanent equipment identifier (PEI), requested network slice selection assistance information (NSSAI), a last accessed tracking area identifier (TAI), and other parameters.

Registration types of the UE include a first registration, a mobile registration update, a periodic registration update, and an emergency registration. The last accessed TAI may be included in a new registration request message to help an access management function (AMF) configure a registration area (RA) for the UE.

2) The AMF is selected, which may include: selecting the AMF by an (R)AN according to a radio access technology or an access technology ((R)AT), and requesting NSSAI. In a case where an appropriate AMF cannot be selected by the (R)AN, the registration request message is forwarded to an AMF configured in the (R)AN.

3) A registration request is sent to a new AMF by the (R)AN, for example, the registration request is sent by sending an N2 message. The message includes N2 parameters, a registration request, etc. The N2 parameters include a selected public land mobile network (PLMN) identification (ID), location information, and a cell identifier associated with a cell where the UE resides.

4) A context transfer (Namf_UEContext Transfer) is performed.

5) In a case where the serving AMF has changed since the last registration, the new AMF may retrieve the stored subscriber Permanent Identifier (SUPI) and UE context of the UE from the old AMF. In a case where the SUCI is not provided by the UE and is not obtained from the old AMF, the new AMF initiates an identity request procedure to the UE, requesting the SUCI.

6) It may be decided by the new AMF to start UE authentication by invoking an authentication server function (AUSF). The AUSF is selected by the AMF according to the SUPI or the SUCI.

7) In a case where the AMF has changed since the last registration, or in a case where the UE provides a SUPI that does not refer to a valid context in the AMF, the AMF selects a UDM based on the SUPI and registers with the UDM. In a case where the AMF does not have the subscription data for the UE, it retrieves the access, mobility subscription, and other data from the UDM.

8) The new AMF performs an AM Policy Association Establishment/Modification to the PCF.

9) In a case where a list of to-be-activated PDU sessions is included in the registration request in step 1, a request (Nsmf_PDUSession_UpdateSMContext request) for obtaining a session update of the UE is sent by the AMF to an SMF associated with the PDU sessions to activate user plane (UP) connections of these PDU sessions.

10) A registration acceptance message is sent to the UE by the new AMF, which indicates that the registration request has been accepted. The registration acceptance message includes a registration area, a mobile restriction, allowed NSSAI, a strictly periodic registration timer indication, etc.

In a case where a new registration area is assigned by the AMF, the new registration area is sent to the UE by AM. In a case where information about the registration area is not included in the registration acceptance message, an old registration area is considered to be valid by the UE.

In a case where the mobile restriction is applicable to the UE and the registration type is not the emergency registration, the mobile restriction is included.

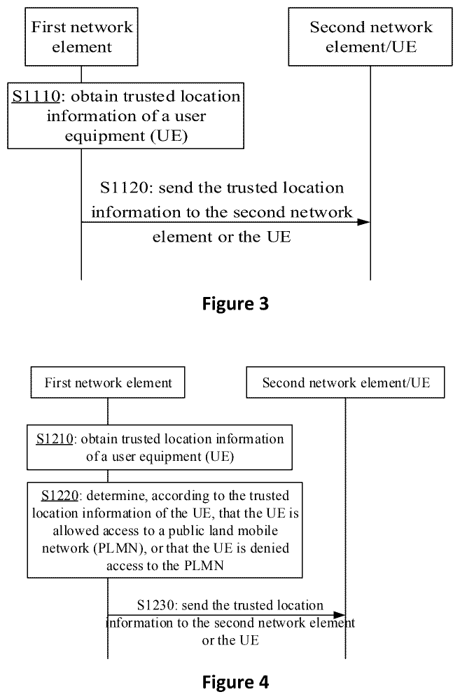

As shown in FIG. 3, a method for processing information is provided according to an embodiment of the present disclosure. The method is performed by a first network element, which includes steps S1110 and S11120 as follows.
S1110: trusted location information of user equipment (UE) is obtained.
S1120: the trusted location information is sent to a second network element or the UE.

The first network element may be a variety of network elements of a core network. For example, the network element includes, but is not limited to, an AMF.

The second network element may be a variety of network elements of an access network. For example, the second network element may include but is not limited to an eNB or gNB.

In a case where the first network element is an AMF and the second network element is a base station, the trusted location information is sent to the base station using an N2 message or an NGAP message.

In a case where the first network element is an AMF, and then the trusted location information may be sent to the UE by using an NAS message.

The trusted location information may be location information that indicates a location where the UE is located and is trusted by a core network.

For example, the trusted location information includes, but is not limited to: location information obtained by locating the UE using the communication network that includes the first network element.

After the trusted location information is sent to the second network element or the UE by the first network element, an operation related to the location where the UE is located may be performed by the UE and/or the second network element using the trusted location information.

In some embodiments, the trusted location information of the UE may be:
location information of the UE obtained by the first network element based on a location service (LCS) procedure; or location information of the UE verified by a network.

In the embodiment of the present disclosure, the trusted location information of the UE may be the location information of the UE obtained according to the LCS procedure. A network-based location measurement calculation method may be used for obtaining the location information of the UE by using the LCS procedure, and the location information of the UE obtained based on the locating method can be trusted. The LCS procedure may be based on the corresponding procedure defined in 3GPP 23.273, which is not limited in the present disclosure.

In some other embodiments, the trusted location information may further be the location information verified by the network including the first network element. In a case where the location information is verified by the first network element, the location information is considered to be the trusted location information. For example, the location information of the UE may be verified by the first network element according to an operation policy, and the verified information is considered trusted.

In some embodiments, the trusted location information includes at least one of the following:
satellite positioning information for identifying the UE;
a TAI for identifying a tracking area where the UE is located;
a cell identifier for identifying a cell where the UE is located; or
a base station identifier for identifying a base station to which the UE is connected.

The satellite positioning information may include: location information obtained based on a satellite positioning system. The location information includes, but is not limited to: longitude and latitude information.

For example, the TAI for identifying the tracking area where the UE is located may be determined according to a TA to which the current location of the UE belongs.

As shown in FIG. 4, a method for processing information is provided according to an embodiment of the present disclosure. The method is performed by a first network element, which includes S1210 to S1230 as follows.
S1210: trusted location information of user equipment (UE) is obtained.
S1220: according to the trusted location information of the UE, it is determined that the UE is allowed to access to the PLMN to which the first network element belongs or that the UE is denied to access to the PLMN to which the first network element belongs.
S1230: the trusted location information is sent to a second network element or the UE.

Such embodiment may be executed alone or implemented in combination with the above example.

By determining whether the UE is allowed to request access to the PLMN according to the trusted location information of the UE, it can reduce erroneous access denials or erroneous access permissions caused by controlling UE access to the PLMN according to untrusted location information, thereby enhancing the accuracy of UE access control.

For example, the UE is located in a border area of a country A and a country B and uses satellite access. The UE belonging to the country A selects a network of an operator in the country B for access, a network device of the operator in the country B determines that a current location of the UE is located in the country A, and the UE is forbidden from accessing the network by using a non-roaming mode at the current location according to the laws of the country B.

For example, the trusted location information may be carried in a registration acceptance message sent to the UE, to be sent to the second network element or the UE.

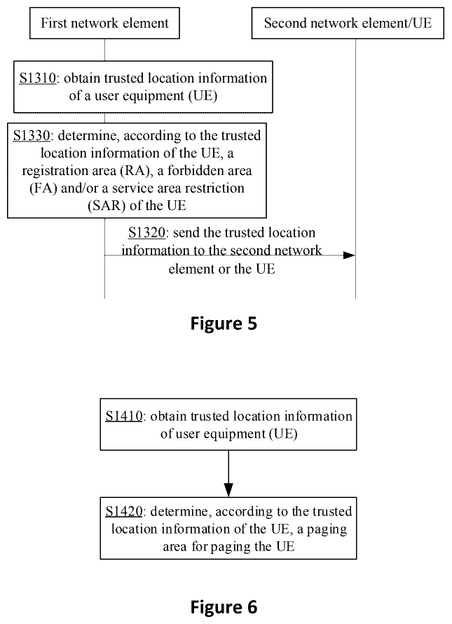

As shown in FIG. 5, a method for processing information is provided according to an embodiment of the present disclosure. The method is performed by a first network element, which includes as follows:
S1310: trusted location information of user equipment (UE) is obtained;
S1320: the trusted location information is sent to a second network element or the UE; and
S1330: according to the trusted location information of the UE, a registration area (RA), a forbidden area (FA) and/or a service area restriction (SAR) of the UE is determined.

The embodiment may be executed alone or implemented in combination with the above embodiments. In addition, in this embodiment, there is no certain order between S1320 and S1330, S1320 may be executed first and then S1330 may be executed, or S1330 may be executed first and then S1320 may be executed. Or S1320 and S1330 are executed simultaneously.

The RA may include one or more TAs and may be used for paging the UE. The FA may include: one or more TAs where the UE access is forbidden.

The SAR may include: one or more TAs where the UE access is allowed, and/or one or more TAs where UE access is restricted.

After the information of the RA, the FA or the SAR is determined, the information is sent to the corresponding UE by the first network element, which then facilitates the UE to perform the network access and/or registration update according to its own location and the information of the RA, the FA, and/or the SAR.

In the embodiment of the present disclosure, since the trusted location information of the UE is sent to the UE by the first network element in S1320, the trusted location information authenticated by the network side is received by the UE. The RA, the FA, and the SAR constructed by the first network element are further received by the UE.

In another embodiment, a method for processing information is provided, the method is performed by a first network element, which includes as follows:
S1310: trusted location information of user equipment (UE) is obtained; and
S1330: according to the trusted location information of the UE, a registration area (RA), a forbidden area (FA) and/or a service area restriction (SAR) of the UE is determined.

In this embodiment, the trusted location information of the UE determined by the first network element is not sent to the UE or the second network element. Instead, the trusted location information of the UE may further be obtained by the UE or the second network element from other network elements, for example, the trusted location information of the UE is received from a location management function (LMF).

This embodiment may be executed alone or implemented in combination with the above embodiments.

As shown in FIG. 6, a method for processing information is provided according to an embodiment of the present disclosure. The method is performed by a first network element, which includes as follows:
S1410: trusted location information of user equipment (UE) is obtained; and
S1420: according to the trusted location information of the UE, a paging area for paging the UE is determined.

This embodiment may be executed alone or implemented in combination with the above embodiments. Since the paging area of the UE is determined according to the trusted location information, it can reduce paging failures caused by imprecise paging ranges, thereby improving the paging success rate.

The paging area may include one or more TAs.

For example, after the UE enters an idle state, in a case where the network side has data to send to the UE, it can page the UE using a paging message. Once the paged UE receives the paging message, it will exit the idle state and switch to the connected state, etc. After the UE switches to the connected state, the network side can send data to the UE through the network connection.

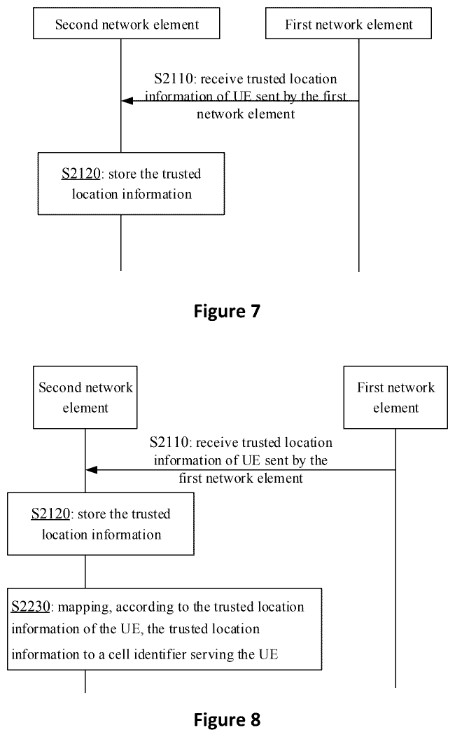

As shown in FIG. 7, a method for processing information is provided according to an embodiment of the present disclosure. The method is performed by a second network element, which includes as follows:
S2110: trusted location information of UE sent by a first network element is received; and
S2120: the trusted location information is stored.

The second network element may be an access network element, includes, but is not limited to, a base station, etc.

The first network element may be a network element of a core network, includes, but is not limited to, an AMF, etc.

For example, the trusted location information that is verified or obtained based on a specific obtaining mode may be received by the second network element from the first network element, thus the quality of a service can be improved when the location-related service is provided based on the trusted location information of the UE.

In some embodiments, the trusted location information includes at least one of the following:
satellite positioning information for identifying the UE;
a TAI for identifying a tracking area where the UE is located;
a cell identifier for identifying a cell where the UE is located; or
a base station identifier for identifying a base station to which the UE is connected.

The satellite positioning information may include: location information obtained based on a global positioning system. The location information includes but is not limited to: longitude and latitude information.

For example, the TAI for identifying the tracking area where the UE is located may be determined according to a TA to which the current location of the UE belongs.

As shown in FIG. 8, a method for processing information is provided according to an embodiment of the present disclosure. The method is performed by a second network element, which includes as follows:
S2210: trusted location information of UE sent by a first network element is received;
S2220: the trusted location information is stored; and
S2230: according to the trusted location information of the UE, the trusted location information is mapped to a cell identifier serving the UE.

In the embodiment of the present disclosure, the trusted location information is mapped to cell information, so that a cell used for serving access of the UE may be known.

In a case where the cell where the UE is located is determined, the paging message may be sent only in the corresponding cell when paging the UE, thereby reducing the paging signaling that needs to be issued by the network.

For example, S2230 may specifically include: mapping the trusted location information to the cell information serving the UE according to the trusted location information of the UE.

It should be noted that the embodiment may be executed alone or implemented in combination with the above embodiments.

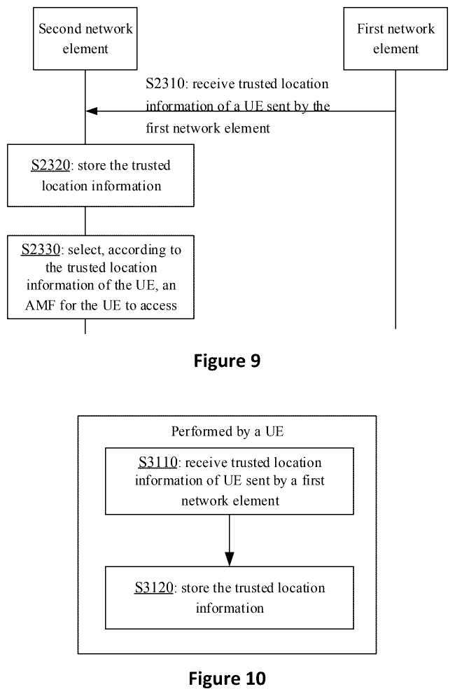

As shown in FIG. 9, a method for processing information is provided according to an embodiment of the present disclosure. The method is performed by a second network element, which includes as follows:
S2310: trusted location information of UE sent by a first network element is received;
S2320: the trusted location information is stored; and
S2330: according to the trusted location information of the UE, an AMF is selected for the UE to access.

It should be noted that that the example may be implemented in combination with the above embodiments performed by the second network element or may be executed alone.

In some embodiments, in the embodiments of the present disclosure, selecting an AMF according to the trusted location information can reduce the selection of an AMF based on inaccurate or falsified location information, decrease AMF reselection, improve access efficiency, and reduce the instances of the UE being denied when requesting access to an incorrect AMF.

As shown in FIG. 10, a method for processing information is provided according to an embodiment of the present disclosure. The method is performed by UE, which includes as follows:
S3110: trusted location information of UE sent by a first network element is received; and
S3120: the trusted location information is stored.

The UE may be of various types, and may be a mobile phone, a tablet computer, a wearable device, a vehicle-mounted device, a smart home device or a smart office device.

The first network element may be a network element of a core network. For example, the network element of the core network is an AMF.

For example, an NAS message including the trusted location information is received by the UE.

After the trusted location information is received, the trusted location information is stored locally, and a subsequent location-related service may provide a trusted service based on the trusted location information, and the quality of service is improved.

In some embodiments, the trusted location information includes at least one of the following:
longitude and latitude information for identifying the UE, for example, the longitude and latitude information may be satellite positioning information obtained by satellite positioning;
a TAI for identifying a tracking area where the UE is located;
a cell identifier for identifying a cell where the UE is located; or
a base station identifier for identifying a base station to which the UE is connected.

The satellite positioning information may include: location information obtained based on a satellite positioning system. The location information includes but is not limited to: longitude and latitude information.

For example, the TAI for identifying the tracking area where the UE is located may be determined according to a TA to which the current location of the UE belongs.

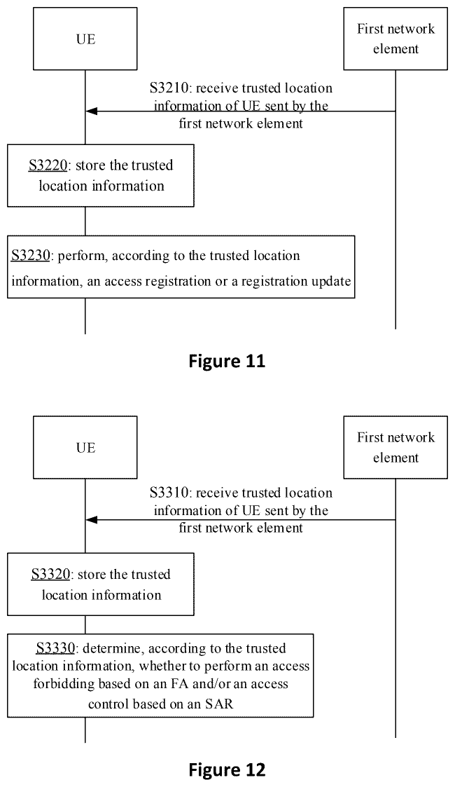

As shown in FIG. 11, a method for processing information is provided according to an embodiment of the present disclosure. The method is performed by UE, which includes as follows:
S3210: trusted location information of UE sent by a first network element is received;
S3220: the trusted location information is stored; and
S3230: according to the trusted location information, an access registration or registration update is performed.

It should be noted that the method for processing information performed by the UE may be executed alone or in combination with the method for processing information executed by the UE above.

In some embodiments, in this way, the access registration or the registration update is performed by the UE according to the trusted location information, so that the access of the UE may be better controlled by a network, such as implementing compliance verification.

As shown in FIG. 12, a method for processing information is provided according to an embodiment of the present disclosure. The method is performed by UE, which includes as follows:
S3310: trusted location information of the UE sent by a first network element is received;
S3320: the trusted location information is stored.
S3330: according to the trusted location information, whether to perform an access forbidding based on an FA and/or an access control based on an SAR is determined.

An access control is performed for the UE according to the trusted location information and combined with the FA or the SAF, so that the accurate control of the UE may be realized.

It should be noted that the method for processing information executed by the UE may be executed alone or in combination with the method for processing information executed by the UE above.

Given that the location information provided by the UE may be untrustworthy and could involve location spoofing, a method for the network side to provide trusted location information of the UE is provided according to the present disclosure, addressing issues such as network control failures caused by untrustworthy UE location information. The specific implementation may include:
trusted location information of the UE is obtained by a first network element and provided to a second network element. The first network element is a network element of a core network, such as an AMF, etc. The second network element is an access network element, such as gNB, or UE.

The location information obtained by the first network element through an LCS procedure may be considered as the trusted location information.

The location information verified by the first network element may be considered as the trusted location information.

The location information of the UE may be any information that identifies the location of the UE, such as global navigation satellite system (GNSS) information or tracking area identity (TAI), etc.

The location information that is considered as the trusted location information may be provided to the first network element by the second network element. Alternatively, the second network element provides the location information to the first network element upon request.

When the second network element is a network element of an access network, it performs Cell ID mapping according to the trusted location information of the UE to select the AMF.

When the second network element is UE, according to the trusted location information of the UE, the second network element performs the selection of a PLMN, determination of registration update, an SAR and/or FR control, etc.

In this embodiment, when the UE accesses a fifth-generation core network (5GC) through a satellite, during initial access, location information A of the UE is provided by the UE, and gNB selects PLMN_A for access according to the location information A to complete a process of initial access attachment.

Subsequently, an LCS process is initiated by AMF_A to obtain location information B of the UE, location verification is performed according to the location information B, and the location information B is one of the trusted location information above.

AMF_A may discovery that the UE is located in a location indicated by the trusted location information B, where access to PLMN_A is prohibited. AMF_A initiates a detach procedure for the UE and provides the trusted location information B to the gNB, which then performs PLMN selection and completes the re-access process.

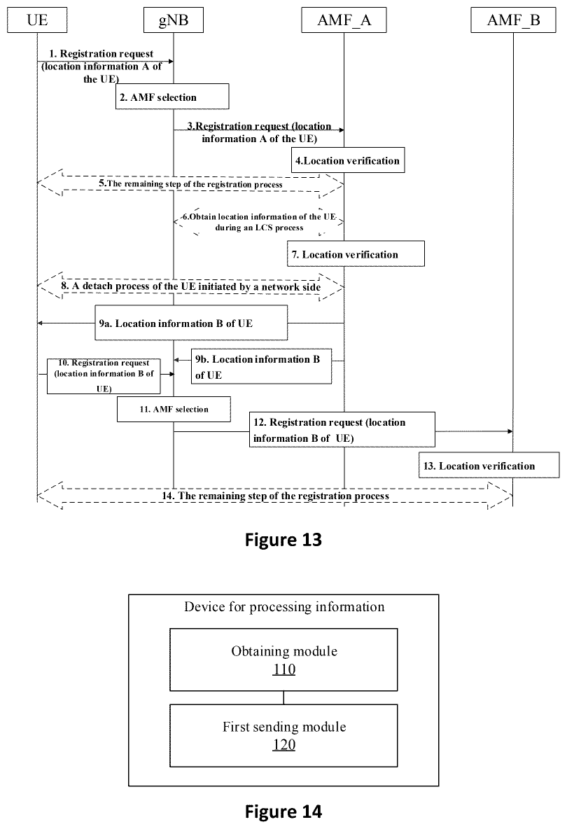

As shown in FIG. 13, a method for processing information is provided according to an embodiment of the present disclosure. The method may include as follows.

1. A registration request is initiated by UE, and location information A of the UE is carried.

2. After the registration request is received, AMF selection is executed by a gNB according to the location information, where an AMF_A is selected.

3. The location information A is mapped to a corresponding CGI by the gNB, and the CGI is included in an NGAP message and sent to the AMF_A.

4. Location verification is completed by the AMF_A, and the UE is allowed to access a PLMN_A at a location A.

5. The remaining process of an access registration is completed between the UE and the AMF_A.

6. An LCS process is initiated by the AMF_A, and location information B of the UE is obtained, where the location information B is the trusted location information above.

7. AMF_A performs the location verification according to the location information B, and determines that the UE is forbidden from accessing the PLMN_A at a location B.

8. A de-registration process is initiated by the AMF_A.

9. The location information B of the UE is provided to the UE and/or the gNB by the AMF_A. For example, this step can be achieved by AMF_A sending a message to the UE and/or sending a message to the gNB during the detach procedure.

10. A PLMN_B is selected by the UE according to the obtained location information B, and a process of a registration request is reinitiated.

11. AMF selection is performed by the gNB according to the location information B of the UE, e.g., AMF_B is selected.

12. The location information B of the UE is mapped to a corresponding cell ID by the gNB, and the cell ID and a registration request are sent to the AMF_B.

13. Location verification is completed by the AMF_B according to the location information B, and the UE is allowed to access the PLMN_B at the location B.

14. The remaining steps of the registration process are completed between the UE and AMF_B.

As shown in FIG. 14, a device for processing information is provided according to an embodiment of the present disclosure. The device includes:
an obtaining module 110, configured to obtain trusted location information of a user equipment (UE); and
a first sending module 120, configured to send the trusted location information to a second network element or the UE.

The device for processing information may be included in a first network element which may include but is not limited to an AMF.

In some embodiments, the obtaining module 110 and the first sending module 120 include but are not limited to a variety of program modules. After the LCS modules are executed by a processor, the above operations can be implemented.

In some other embodiments, the obtaining module 110 and the first sending module 120 include but are not limited to software-hardware combined modules which include but are not limited a variety of programmable arrays. The programmable arrays include but are not limited to field programmable arrays and/or complex programmable arrays.

In some embodiments, the obtaining module 110 and the first sending module 120 include but are not limited to pure-hardware modules which include but are not limited to a variety of application-specific integrated circuits.

In some embodiments, the trusted location information of the UE may be location information of the UE obtained by the first network element based on a location service (LCS) procedure; or location information of the UE verified by a network.

In some embodiments, the trusted location information includes at least one of the following:
longitude and latitude information identifying the UE;
a TAI for identifying a tracking area where the UE is located;
a cell identifier for identifying a cell where the UE is located; or
a base station identifier for identifying a base station to which the UE is connected.

In some embodiments, the device further includes:
a first determining module, configured to determine, before sending the trusted location information to the second network element or the UE, that the UE is allowed to access to a public land mobile network (PLMN) to which the first network element belongs or that the UE is denied to access to the PLMN to which the first network element belongs, according to the trusted location information of the UE.

In some embodiments, the device further includes:
a second determining module, configured to determine, according to the trusted location information of the UE, a registration area (RA), a forbidden area (FA) and/or a service area restriction (SAR) of the UE; or determine, according to the trusted location information of the UE, a paging area for paging the UE.

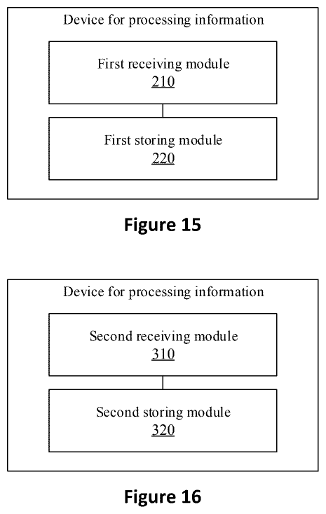

As shown in FIG. 15, a device for processing information is provided according to an embodiment of the present disclosure, the device includes:
a first receiving module 210, configured to receive trusted location information of UE sent by a first network element; and
a first storing module 220, configured to store the trusted location information.

The device for processing information may be included in a second network element which may include but is not limited to an AMF.

In some embodiments, the first receiving module 210 and the first storing module 220 include but are not limited to a variety of program modules. After the program modules are executed by a processor, the above operations can be implemented.

In some other embodiments, the first receiving module 210 and the first storing module 220 include but are not limited to software-hardware combined modules which include but are not limited a variety of programmable arrays. The programmable arrays include but are not limited to field programmable arrays and/or complex programmable arrays.

In some embodiments, the first receiving module 210 and the first storing module 220 include but are not limited to pure-hardware modules which include but are not limited to a variety of application-specific integrated circuits.

In some embodiments, the device further includes:
a first executing module, configured to execute, according to the trusted location information of the UE, a mapping of the trusted location information to cell information. For example, the first executing module is configured to execute, according to the trusted location information of the UE, a mapping of the trusted location information to cell information serving the UE.

In some embodiments, the device further includes:
a selecting module, configured to select an AMF for the UE to access according to the trusted location information of the UE.

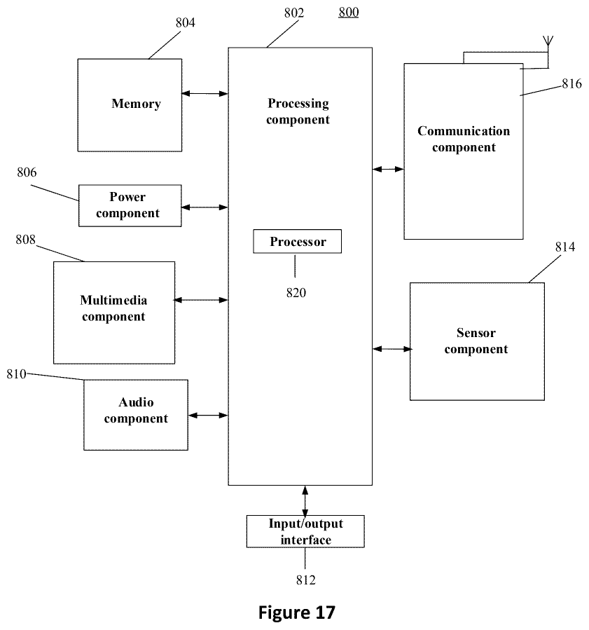

As shown in FIG. 16, a device for processing information is provided according to an embodiment of the present disclosure. The device includes:
a second receiving module 310, configured to receive trusted location information of UE sent by a first network element; and
a second storing module 320, configured to store the trusted location information.

The device for processing information may be included in the UE.

In some embodiments, the second receiving module 310 and the second storing module 320 may be program modules. After the program modules are executed by a processor, the above operations can be implemented.

In some other examples, the second receiving module 310 and the second storing module 320 may be software and hardware combined modules. The software and hardware combined modules include but are not limited to programmable arrays. The programmable arrays include but are not limited to field programmable arrays and/or complex programmable arrays.

In some embodiments, the second receiving module 310 and second storing module 320 may be pure-hardware modules which include but are not limited to application-specific integrated circuits.

In some embodiments, the device further includes:
a second executing module, configured to execute, according to the trusted location information, an access registration or a registration update.

In some embodiments, the device further includes:
a third determining module, configured to determine, according to the trusted location information, whether to execute access forbidding based on a forbidden area (FA) and/or an access control based on a service area restriction (SAR).

A communication device is provided according to an example of the present disclosure. The communication device includes:
a memory that stores processor executable instructions;
a processor, connected to the memory;
where, the processor is configured to implement the method for processing information provided by any technical solutions above.

The processor may include storage media of various types. The storage media are non-transitory computer storage media, which can continue to memorize information stored after a communication device is powered down.

Here, the communication device includes: UE or a network element, and the network element may be any one of a first network element, a second network element, or the UE.

The processor may be connected with the memory via a bus and the like, and is configured to read the executable program stored on the memory, such as at least one of the methods shown in FIG. 2 to FIG. 13.

FIG. 17 is a block diagram of UE 800 illustrated according to an example. For example, the UE 800 may be a mobile phone, a computer, digital broadcasting user equipment, a messaging device, a game console, a tablet device, a medical device, a fitness device, a personal digital assistant, etc.

Referring to FIG. 17, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the UE 800, such as operations associated with display, telephone call, data communication, camera operations, and recording operations. The processing component 802 may include one or more processors 820 to execute instructions to generate all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the UE 800. Examples of these data include instructions for any application or method operating on the UE 800, contact data, phonebook data, messages, pictures, videos, etc. The memory 804 may be implemented by any type of volatile or nonvolatile storage device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power component 806 provides power for various components of the UE 800. The power component 806 may include a power management system, one or more power sources and other components associated with generating, managing and distributing power for the UE 800.

The multimedia component 808 includes a screen providing an output interface between the UE 800 and a user. In some embodiments, the screen may include a liquid crystal display (LCD) and a touch panel (TP). In a case where the screen includes the touch panel, the screen may be implemented as a touch screen to receive an input signal from the user. The touch panel includes one or more touch sensors to sense a touch, sliding and gestures on the touch panel. The touch sensor can not only sense the boundary of the touch or sliding operation, but also detect the duration and pressure related to the touch or sliding operation. In some embodiments, the multimedia component 808 includes a front camera and/or a rear camera. When the UE 800 is in an operation mode, such as a shooting mode or a video mode, the front camera and/or the rear camera can receive external multimedia data. Each front camera and rear camera may be a fixed optical lens system or have a focal length and optical zoom capability.

The audio component 810 is configured to output and/or input audio signals. For example, the audio component 810 includes a microphone (MIC) configured to receive an external audio signal when the UE800 is in the operation mode, such as a call mode, a recording mode, and a speech recognition mode. The received audio signal may be further stored in the memory 804 or transmitted via the communication component 816. In some embodiments, the audio component 810 also includes a speaker for outputting an audio signal.

The I/O interface 812 provides an interface between the processing component 802 and a peripheral interface module which may be a keyboard, a click wheel, a button, etc. These buttons may include but are not limited to: a home button, a volume button, a start button and a lock button.

The sensor component 814 includes one or more sensors for providing state evaluation of various aspects of the UE 800. For example, the sensor component 814 can detect an on/off state of the UE 800 and the relative positioning of the components, for example, the component is a display and a keypad of the UE 800. The sensor component 814 may also detect the change in the position of the UE 800 or one component of the UE 800, the presence or absence of user contact with the UE 800, the orientation or acceleration/deceleration of the UE 800, and temperature change of the UE 800. The sensor component 814 may include a proximity sensor configured to detect the presence of nearby objects without any physical contact. The sensor component 814 may further include an optical sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 2G or 3G, or their combination. In an example, the communication component 816 receives a broadcast signal or broadcast-related information from an external broadcast management system via a broadcast channel. In an example, the communication component 816 further includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology and other technologies.

In an example, the UE 800 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the above method.

In an example, a non-transitory computer-readable storage medium including instructions is provided, such as the memory 804 including instructions. The instructions can be executed by the processor 820 of the UE 800 to generate the above method. For example, the non-transitory computer-readable storage medium may be an ROM, a random access memory (RAM), a CD-ROM, a magnetic tape, a floppy disk, an optical data storage device, etc.

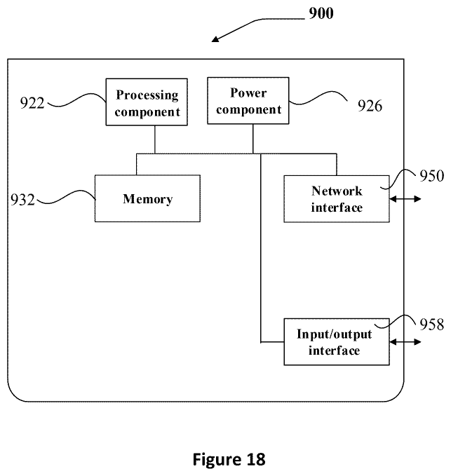

As shown in FIG. 18, a structure of a network device is illustrated according to an example of the present disclosure. For example, a communication device 900 may be provided as a device at the network side. The communication device may be the first network element and/or the second network element described above.

Referring to FIG. 18, the communication device 900 includes a processing component 922, which further includes one or more processors, and a memory resource represented by a memory 932 for storing instructions, such as applications, that can be executed by the processing component 922. The applications stored in the memory 932 may include one or more modules, each of which corresponding to a set of instructions. In addition, the processing component 922 is configured to execute instructions to execute any method applied to the access device above, such as the method shown in any one of FIG. 2 to FIG. 13.

The communication device 900 may further include a power component 926 configured to perform power management of the communication device 900, a wired or wireless network interface 950 configured to connect the communication device 900 to the network, and an input/output (I/O) interface 958. The communication device 900 can operate an operating system based on the memory 932, such as Windows Server™, Mac OS X™, Unix™, Linux™, FreeBSD™, or the like.

In technical solutions provided by the embodiments of the present disclosure, the first network element can inform the second network element or the UE of the determined trusted location information of the UE. In this way, when the second network element provides services based on location information or the UE requests services based on location information, they are executed based on the trusted location information. This approach improves the service quality and execution accuracy of the services that is based on location information compared with services provided or obtained based on untrusted or incorrect location information.

Those skilled in the art will readily conceive other implementations of the embodiments of the present disclosure upon consideration of the specification and practice of the present disclosure here. The present disclosure is intended to cover any variations, uses, or adaptations of the embodiments of the present disclosure. These variations, uses, or adaptations comply with the general principles of the embodiments of the present disclosure, and include common knowledge or customary technical means in the art which are not disclosed herein. The specification and embodiments are to be considered as illustrative merely, and the scope and spirit of the embodiments of the present disclosure are defined by the following claims.

It should be understood that the present disclosure is not limited to precise structures described above and shown in the accompanying drawings, and various modifications and changes can be made without departing from the scope of the present disclosure. The scope of the present disclosure is defined by the following claims.

1. A method for processing information, performed by a first network element, the method comprising:
obtaining trusted location information of a user equipment (UE); and
sending the trusted location information to a second network element or the UE.

2. The method for processing information according to claim 1, wherein the trusted location information of the UE is: location information of the UE obtained by the first network element based on a location service (LCS) procedure; or the trusted location information of the UE is location information of the UE verified by a network.

3. The method for processing information according to claim 1, wherein the trusted location information comprises at least one of: longitude and latitude information identifying the UE, a tracking area identifier (TAI) for identifying a tracking area where the UE is located, a cell identifier for identifying a cell where the UE is located, or a base station identifier for identifying a base station to which the UE is connected.

4. The method for processing information according to claim 1, wherein before sending the trusted location information to the second network element or the UE, the method further comprises:
determining, according to the trusted location information of the UE, that the UE is allowed to access to a public land mobile network (PLMN) to which the first network element belongs, or that the UE is denied to access to the PLMN to which the first network element belongs.

5. The method for processing information according to claim 4, further comprising:
determining, according to the trusted location information of the UE, a registration area (RA), a forbidden area (FA) and/or a service area restriction (SAR) of the UE; or
determining, according to the trusted location information of the UE, a paging area for paging the UE.

6. A method for processing information, performed by a second network element, the method comprising:
receiving trusted location information of a user equipment (UE) sent by a first network element; and
storing the trusted location information.

7. The method for processing information according to claim 6, further comprising:
mapping the trusted location information to cell information serving the UE according to the trusted location information of the UE.

8. The method for processing information according to claim 6, further comprising:
selecting an access and mobility management function (AMF) for the UE to access according to the trusted location information of the UE.

9. A method for processing information, performed by a user equipment (UE), the method comprising:
receiving trusted location information of the UE sent by a first network element; and
storing the trusted location information.

10. The method for processing information according to claim 9, further comprising:
performing an access registration or a registration update according to the trusted location information.

11. The method for processing information according to claim 9, further comprising:
determining, according to the trusted location information, whether to perform access forbidding based on a forbidden area (FA) and/or an access control based on a service area restriction (SAR).

12. (canceled)

13. (canceled)

14. (canceled)

15. A communication device, comprising:
a processor;
a transceiver;
a memory; and
an executable program stored on the memory and capable of being operated by the processor, wherein the processor implements the method for processing information according to claim 1 when running the executable program.

16. A non-transitory computer storage medium, storing an executable program, wherein the executable program when executed by a processor, implements the method for processing information according to claim 1.

17. A communication device, comprising:
a processor;
a transceiver;
a memory; and
an executable program stored on the memory and capable of being operated by the processor, wherein the processor implements the method for processing information according to claim 6 when running the executable program.

18. A communication device, comprising:
a processor;
a transceiver;
a memory; and
an executable program stored on the memory and capable of being operated by the processor, wherein the processor implements the method for processing information according to claim 9 when running the executable program.

19. A non-transitory computer storage medium, storing an executable program, wherein the executable program when executed by a processor, implements the method for processing information according to claim 6.

20. A non-transitory computer storage medium, storing an executable program, wherein the executable program when executed by a processor, implements the method for processing information according to claim 9.

21. The method according to claim 2, wherein the trusted location information comprises at least one of longitude and latitude information identifying the UE, a TAI for identifying a tracking area where the UE is located, a cell identifier for identifying a cell where the UE is located, or a base station identifier for identifying a base station to which the UE is connected.
